(19) United States
(12) Patent Application Publication
(10) Pub. No.: US 2012/0191406 A1
(43) Pub. Date: Jul. 26, 2012

(54) ANGULAR SPEED DETECTION APPARATUS AND METHOD FOR DETECTING ANGULAR SPEED ERROR

(75) Inventors: Hirofumi OKUMURA, Miyagi-ken (JP); Tsukasa MIZUSAWA, Miyagi-ken (JP)

(73) Assignee: Alps Electric Co., Ltd., Ota-ku (JP)

(21) Appl. No.: 13/357,111

(22) Filed: Jan. 24, 2012

(30) Foreign Application Priority Data
Jan. 24, 2011 (JP) 2011-011994

(51) Int. Cl. G01P 3/00; G06F 15/00

(52) U.S. Cl. 702/146

(57) ABSTRACT

In an angular speed detection apparatus according to the present embodiment, in a positive counter, a first counter value P is obtained by adding 3 when an average angular speed

“ASMAV (deg/s)” calculated at each “time” is higher than or equal to, for example, 3000 (deg/s) and subtracting 1 when the average angular speed is lower than 3000. In a negative counter, a second counter value M is obtained by adding 3 when the average angular speed “ASMAV (deg/s)” is lower than or equal to −3000 (deg/s) and subtracting 1 when the average angular speed is higher than −3000. When the first counter value or the second counter value has exceeded a predetermined error threshold (for example, 20), it is determined that an error has occurred.

### CLAIM OF PRIORITY

This application contains information related to and claims the benefit of Japanese Patent Application No. 2011-011994 filed on Jan. 24, 2011, the contents of which is hereby incorporated by reference in its entirety.

### BACKGROUND OF THE DISCLOSURE

1. Field of the Disclosure

The present disclosure relates to angular speed detection apparatuses, and specifically to angular speed error detection.

2. Description of the Related Art

Japanese Unexamined Patent Application Publication No. 11-59462 discloses an invention relating to a rudder angle sensor abnormality detection apparatus, in which the amount of change in rudder angle output by a rudder angle sensor is accumulated to obtain a computed rudder angle, and when the difference between a rudder angle output by the rudder angle sensor and the computed rudder angle exceeds a predetermined value, it is determined that the sensor is abnormal.

In the related art, noise that causes an abrupt change in angle is likely to be detected as an error. Further, in the related art, it has been difficult to detect an abnormal change in angular speed as an error by discriminating it from noise, without detecting a change in angular speed due to noise as an error.

These and other drawbacks exist.

### SUMMARY OF THE DISCLOSURE

To solve the above-described problems, the present disclosure provides an angular speed detection apparatus and a method for detecting an angular speed error which allow an abnormal change in angular speed to be detected as an error by discriminating it from noise, without detecting a change in angular speed due to noise as an error.

An angular speed detection apparatus according to the present disclosure includes: calculation means configured to obtain, on the basis of angles detected at time intervals T1 that are shorter than a unit time for which angular speeds are calculated, the angular speeds at the time intervals T1 and calculate average angular speeds using a plurality of the prior angular speeds obtained at the time intervals T1; a positive counter configured to obtain a first counter value by adding a predetermined value aa when any of the average angular speeds calculated at the time intervals T1 is higher than or equal to a predetermined positive threshold and subtracting a predetermined value bb when any of the average angular speeds calculated at the time intervals T1 is lower than the predetermined positive threshold; and a negative counter configured to obtain a second counter value by adding a predetermined value cc when any of the average angular speeds calculated at the time intervals T1 is lower than or equal to a predetermined negative threshold and subtracting a predetermined value dd when any of the average angular speeds calculated at the time intervals T1 is higher than the predetermined negative threshold, wherein it is determined that an error has occurred when the first counter value or the second counter value has exceeded an error threshold.

A method of detecting an angular speed error according to the present disclosure includes: obtaining, on the basis of angles detected at time intervals T1 that are shorter than a unit time for which angular speeds are calculated, the angular speeds at the time intervals T1 and calculating average angular speeds using a plurality of the prior angular speeds obtained at the time intervals T1; obtaining a first counter value by adding a predetermined value aa when any of the average angular speeds calculated at the time intervals T1 is higher than or equal to a predetermined positive threshold and subtracting a predetermined value bb when any of the average angular speeds calculated at the time intervals T1 is lower than the predetermined positive threshold; and obtaining a second counter value by adding a predetermined value cc when any of the average angular speeds calculated at the time intervals T1 is lower than or equal to a predetermined negative threshold and subtracting a predetermined value dd when any of the average angular speeds calculated at the time intervals T1 is higher than the predetermined negative threshold, wherein it is determined that an error has occurred when the first counter value or the second counter value has exceeded an error threshold.

By providing the counters in this manner, even when an abnormal average angular speed is detected, this is not immediately determined to be an error. In the present disclosure, the positive counter having a positive threshold set therefor for the average angular speed and the negative counter having a negative threshold set therefor for the average angular speed are provided, rather than a single counter.

For example, for a noise pattern in which a change in angle with respect to time abruptly considerably changes, the average angular speed obtained by the calculation means considerably swings both to positive values and negative values. At this time, in the present disclosure, counting is performed by the positive counter when the average angular speed swings considerably to a positive value and counting is performed by the negative counter when the average angular speed swings considerably to a negative value. Hence, it is easy to perform setting so as to make both the first counter value and the second counter value be smaller than the error threshold, thereby preventing noise from being detected as an error.

A state to be desirably detected as an error is a failure state in which, for example, a short circuit has occurred in an electronic circuit, whereby the detected angle with respect to time swings to a large value and that states continues. In such a failure state, a period of time during which the average angular speed exceeds the threshold becomes long for one of the positive counter and the negative counter. Hence, the counter value associated with a failure can be made to be larger than the counter value associated with noise. As a result, compared with the related art, setting can be appropriately made such that the counter value associated with noise is smaller than the error threshold, and the counter value associated with a failure is larger than the error threshold.

Hence, in the present disclosure compared with the related art, a configuration is realized in which a change in angular speed associated with noise is not detected as an error while an abnormal change in angular speed associated with a failure can be detected as an error. Hence, an angular speed detection apparatus and a method for detecting an angular speed error having an advantage in terms of operational stability and error detection accuracy are realized.

In the present disclosure, the values aa and cc added to the counters may be larger than the values bb and dd subtracted from the counters. This increases the difference between the maximum counter value associated with noise (FIGS. 4 to 6) and the maximum counter value associated with a failure (FIG. 7) and makes it easy to set the error threshold, whereby a configuration having an advantage in terms of operational stability and error detection accuracy is realized.

In the present disclosure, subtraction of the value bb may be performed when the first counter value is larger than a predetermined lower limit at the time of the subtraction and subtraction of the value dd be performed when the second counter value is larger than a predetermined lower limit at the time of the subtraction. By providing a lower limit in subtraction, the difference between the lower limit of each counter and the error threshold can always be made to be constant, whereby the error detection accuracy can be more effectively increased.

According to the angular speed detection apparatus and method for detecting an angular speed error of the present disclosure, unlike the related art, a configuration is realized in which an abnormal change in angular speed associated with a failure can be detected as an error by discriminating it from noise, while a change in angular speed associated with noise is not detected as an error.

### BRIEF DESCRIPTION OF THE DRAWINGS

FIG. 1 is a perspective view of an angular speed detection apparatus according to an embodiment of the disclosure;

FIG. 2 is an electronic circuit diagram according to an embodiment of the present disclosure;

FIG. 3 is a configuration diagram of a microprocessor according to an embodiment of the disclosure;

FIG. 4 illustrates simulation results of a pattern to be recognized as noise, showing “times”, “angles A”, “angular speeds AS”, average angular speeds, the counter values of a positive counter and a negative counter in an embodiment of the disclosure, and the counter values of a counter in a comparative example;

FIG. 5 illustrates simulation results of a pattern to be recognized as noise, showing “times”, “angles A”, “angular speeds AS”, average angular speeds, the counter values of a positive counter and a negative counter in an embodiment of the disclosure, and the counter values of a counter in a comparative example;

FIG. 6 illustrates simulation results of a pattern to be recognized as noise, showing “times”, “angles A”, “angular speeds AS”, average angular speeds, the counter values of a positive counter and a negative counter in an embodiment of the disclosure, and the counter values of a counter in a comparative example;

FIG. 7 illustrates simulation results of a pattern to be detected as an error, showing “times”, “angles A”, “angular speeds AS”, average angular speeds, the counter values of a positive counter and a negative counter in an embodiment of the disclosure, and the counter values of a counter in a comparative example;

FIG. 8A is a flowchart illustrating the increase/decrease of a first counter value calculated by a positive counter of an embodiment of the disclosure and error determination based on the first counter value;

FIG. 8B is a flowchart illustrating the increase/decrease of a second counter value calculated by a negative counter of an embodiment of the disclosure and error determination based on the second counter value; and

FIG. 9 is a flowchart illustrating the increase/decrease of a counter value calculated by a counter of a comparative example and error determination based on the counter value.

### DETAILED DESCRIPTION OF THE DISCLOSURE

The following description is intended to convey a thorough understanding of the embodiments described by providing a number of specific embodiments and details involving an angular speed detection apparatus and related method. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

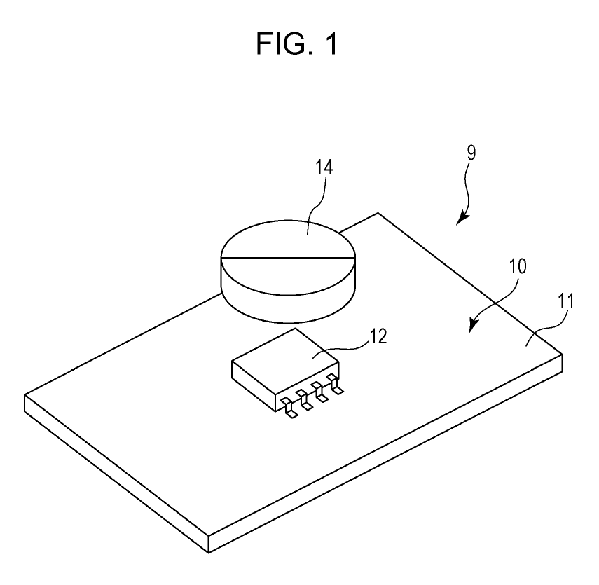

FIG. 1 is a perspective view of an angular speed detection apparatus according to an embodiment of the disclosure.

An angular speed detection apparatus 9 illustrated in FIG. 1 may include a magnetic sensor 10 and a magnet 14.

Referring to FIG. 1, the magnetic sensor 10 may include a printed wiring board 11 and a sensor device 12 electrically connected to the printed wiring board 11. The magnetic sensor 10 and the magnet 14 may be arranged with a space therebetween (non-contact).

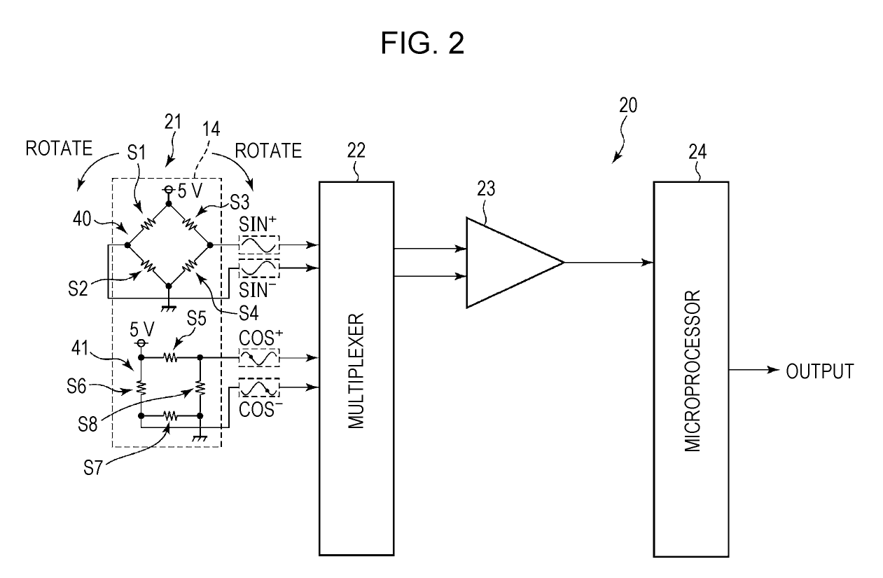

FIG. 2 is a circuit diagram of an electronic circuit 20, which ,may be built in the magnetic sensor 10.

As illustrated in FIG. 2, the electronic circuit 20 may include a magnetic field detection unit 21, a multiplexer 22, an operational amplifier (differential amplifier) 23, and a microprocessor 24.

Referring to FIG. 2, the magnetic field detection unit 21 may be constituted by bridge circuits 40 and 41 may be formed of a plurality of magnetic detection elements (for example, GMR elements) S1, S2, S3, S4, S5, S6, S7, and S8.

Referring to FIG. 2, when the magnet 14 (schematically illustrated using a broken line in FIG. 2) rotates, the electric characteristics of the magnetic detection elements S1 to S8 may be changed, whereby a SIN⁺ signal and a SIN⁻ signal may be output as magnetic field detection signals from the first bridge circuit 40 and a COS⁺ signal and a COS⁻ signal are output as magnetic field detection signals from the second bridge circuit 41. The SIN⁺ signal and SIN⁻ signal may be different in phase by approximately 180 degrees, and the COS⁺ signal and COS⁻ signal may be different in phase by approximately 180 degrees. The SIN⁺ signal and COS⁺ signal may be different in phase by approximately 180 degrees, and the SIN⁻ signal and COS⁻ signal may be different in phase by approximately 90 degrees.

When the SIN⁺ signal and SIN signal are selected by the multiplexer 22 and input to the operational amplifier 23 illustrated in FIG. 2, a SIN signal amplified by the operational amplifier 23 may be obtained.

Similarly, when the COS⁺ signal and COS⁻ signal are selected by the multiplexer 22 and input to the operational amplifier 23 illustrated in FIG. 2, a COS signal amplified by the operational amplifier 23 may be obtained.

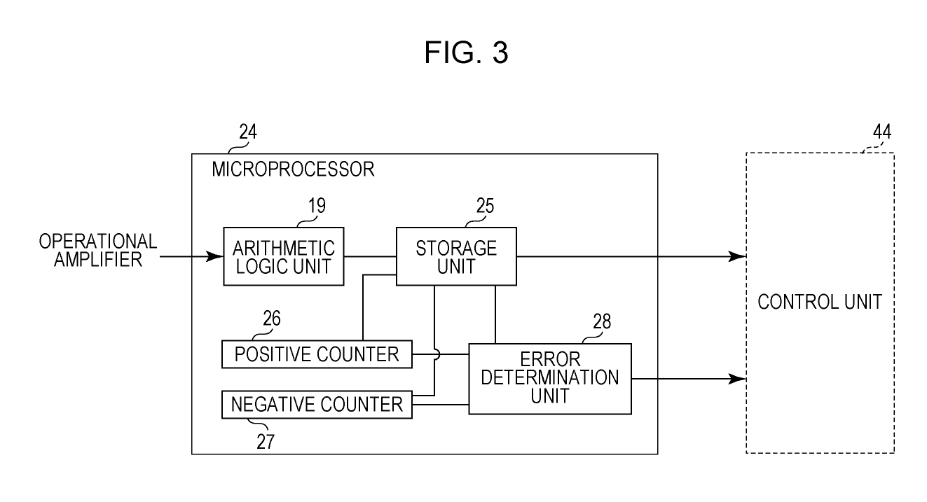

By using the SIN and COS signals generated by the operational amplifier 23, an arc tangent value may be computed by an arithmetic logic unit 19 of the microprocessor 24 illustrated in FIG. 3, and the rotation angle of the magnet 14 may be obtained on the basis of the arc tangent value. The SIN and COS signals may be periodically sent to the arithmetic logic unit 19 at predetermined time intervals T1, whereby the angle of the magnet 14 can be obtained every time interval T1.

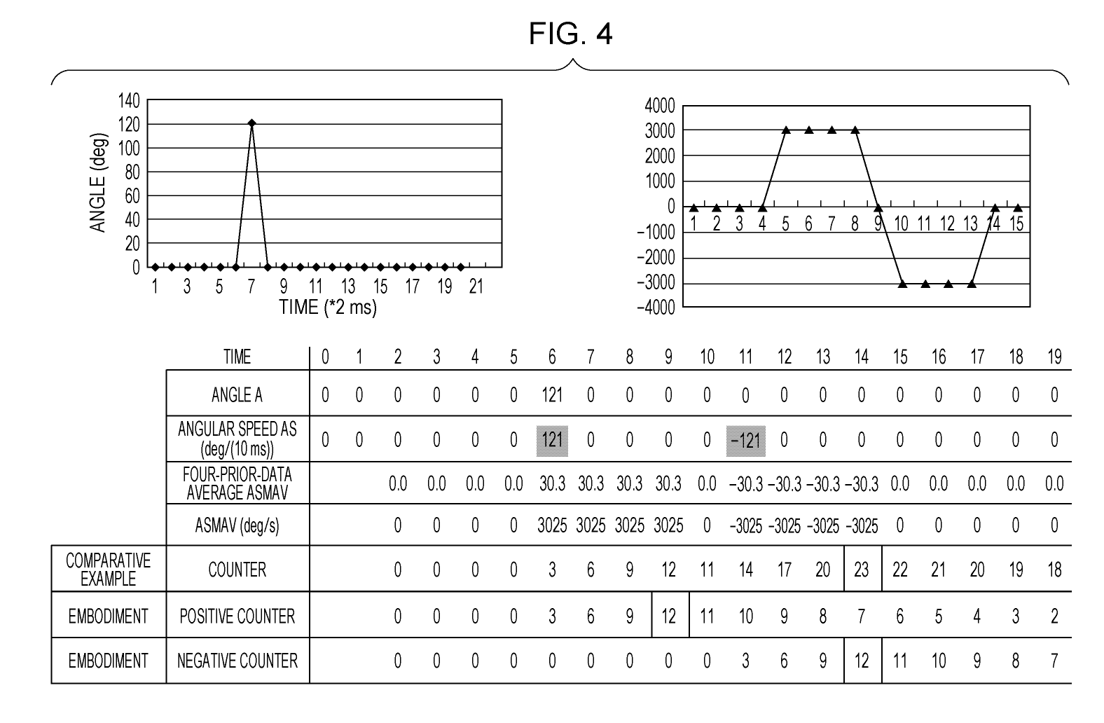

FIG. 4 illustrates the simulation results of a pattern that is to be desirably recognized as noise (pattern not to be detected as an error). Referring to FIG. 4, the left side graph illustrates “angle” versus “time”, and the right side graph illustrates “ASMAV (deg/s)” (average angular speed) versus “time”. A table showing the simulation results is illustrated below the graphs. Hereinafter, description is made mainly on the basis of the table.

Referring to FIG. 4, times (0, 1, 2, 3, . . . ) illustrated in the “time” row represent discrete times at 2 ms intervals (corresponding to the above-described time interval T1). In other words, “1” in the “time” row shows 2 ms after “0”, “2” shows 4 ms after “0”, . . . .

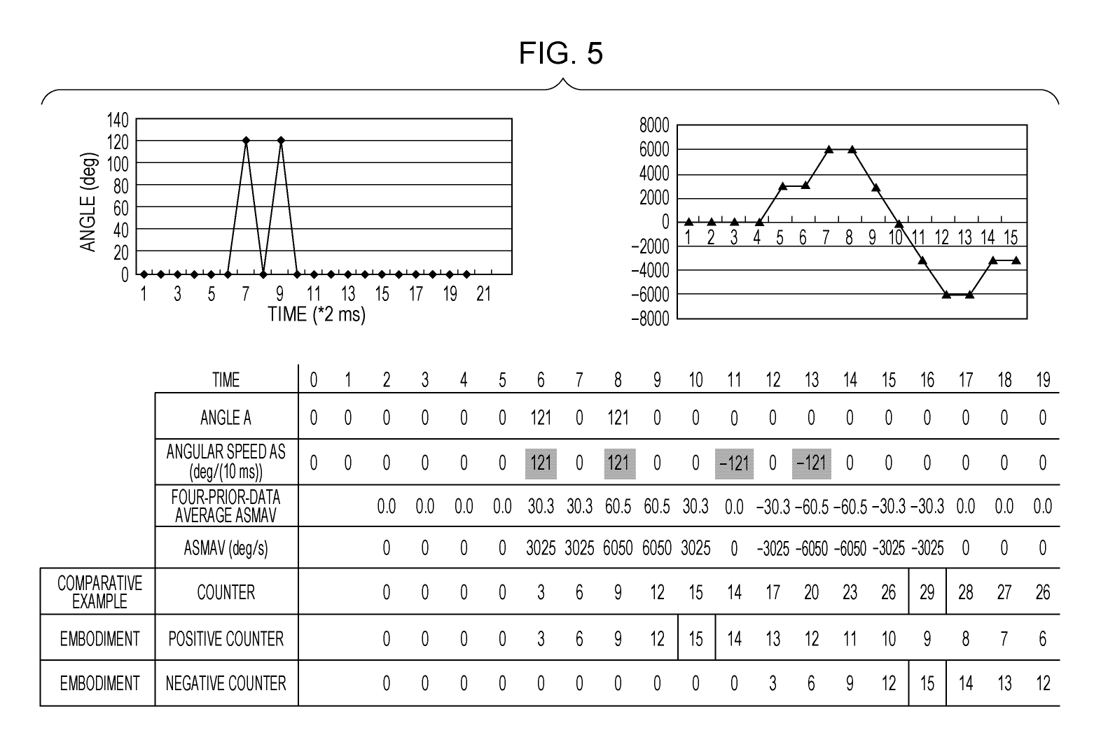

Referring to FIG. 4, the “angle A” row shows the angles of the magnet 14 at the corresponding “times”. In this simulation, the angle may be “0” until “time” reaches “5”. In actual usage, the magnet 14 may rotate and, hence, “angle A” may change. However, in the simulation results illustrated in FIG. 4, in order to make it easy to see abnormally large changes in angle and angular speed, description is made supposing that the magnet 14 is not moving, i.e., an angle of “0” is a fixed reference. This is also true in FIGS. 5 to 7.

In the simulation results illustrated in FIG. 4, the angle abruptly may increase to “121” at time “6” (also see the graph showing a change in angle in FIG. 4). Then, after and including time “7”, the angle returns to “0”. An example of a case in which the angle abruptly changes, as is seen at time “6”, is a case in which externally applied large magnetic force affects the magnetic field generated by the magnet 14.

The “angular speed AS” row illustrated in FIG. 4 shows angular speeds in deg/(10 ms). The angular speed at time “6” is computed by obtaining the change in angular speed between time “1”, which is 10 ms before time “6”, and time “6”. “Angle A” at time “1” is “0”, and “angle A” at time “6”, which is 10 ms after time “1”, is “121”. Hence “angular speed AS” at time “6” is calculated to be “121” deg/(10 ms).

At time “7”, “angle A” returns to “0”, and “angle A” at time “2”, which is 10 ms before time “7”, is also “0”. Hence, “angular speed AS” at time “7” is calculated to be “0”.

Referring to FIG. 4, it can be seen that “angular speed AS” may become “−121” at time “11”. This is because “angle A” is “0” at time “11”, and at time “6”, which is 10 ms before time “11”, “angle A” is “121”.

In this manner, “angular speed AS” (deg/(10 ms)) at “time A” illustrated in FIG. 4 may be obtained on the basis of “angles A” which have been obtained at intervals (2 ms) shorter than a unit time (10 ms) over which the angular speed is calculated.

The “four-prior-data average ASMAV” row illustrated in

FIG. 4 shows average angular speeds each obtained using four angular speeds at times prior to and including the current time.

For example, at time “6”, four angular speeds at times prior to and including the current time may be “121” (at time “6”) and “0” (at times “3” to “5”), hence an average angular speed of “30.3” (deg/(10 ms)) may be obtained by dividing “121” by 4.

Similarly, at time “7”, four angular speeds at times prior to and including the current time are “121” (at time “6”) and “0” (at times “4”, time “5”, and time “7”), an average angular speed of “30.3” (deg/(10 ms)) may be obtained. This also applies to the cases of time “8” and time “9”.

At time “10”, since four angular speeds at times prior to and including the current time are “0” for all the times (times “7” to “10”), the average angular speed may become “0”.

At time “11”, since four angular speeds at times prior to and including the current time are “−121” (at time “11”), and “0” (at times “8” to “10”), an average angular speed of “−30.3” (deg/(10 ms)) may be obtained by dividing “−121” by 4. Similar calculation is performed for other cases.

“ASMAV (deg/s)” illustrated in FIG. 4 may be obtained by changing the unit time for the average angular speed in the “four-prior-data average ASMAV” row illustrated in FIG. 4 from 10 ms to 1 s. Also refer to the graph of “ASMAV (deg/s)” (average angular speed) on the right side of FIG. 4.

A storage unit 25 illustrated in FIG. 3 may store information about “time”, “angle A”, “four-prior-data average ASMAV”, and “ASMAV (deg/s)” illustrated in FIG. 4. Among these pieces of information, information about “angle A” and “ASMAV (deg/s)” may be periodically transmitted to a control unit 44 on the apparatus main body side, for example, at intervals of 10 ms (CAN transmission timing).

Here, “at intervals of 10 ms” means, for example, at times “5”, “10”, “15”, . . . , when time “0” illustrated in FIG. 4 is a start time.

In the present embodiment, “angles A” may be obtained at the time intervals T1 (2 ms) shorter than 10 ms, and an average angular speed may be obtained on the basis of four angular speeds at times prior to and including the current time. Hence, although “angle A” and “angular speed AS” may be “0” at times “5”, “10”, and “15”, which are CAN transmission timings, a change in angular speed based on changes in angular speed during a period of 10 ms can be reflected in the CAN transmission by transmitting an average angular speed obtained using the prior data.

As illustrated in FIG. 4, in the present embodiment, the microprocessor 24 may include a positive counter 26 and a negative counter 27. Information about “time” and “ASMAV (deg/s)” (average angular speed) may be transmitted from the storage unit 25 to the positive counter 26 and the negative counter 27.

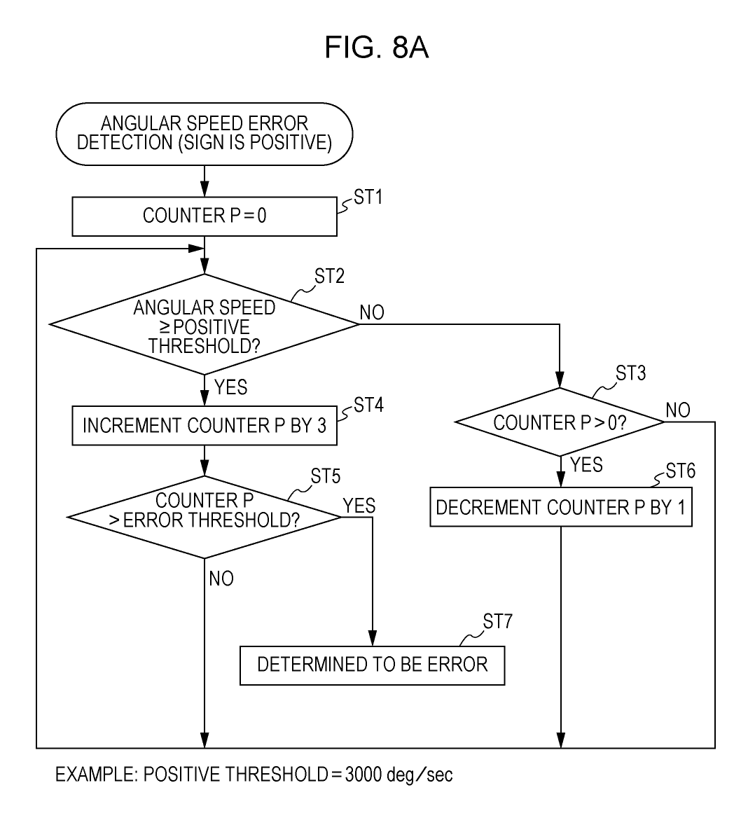

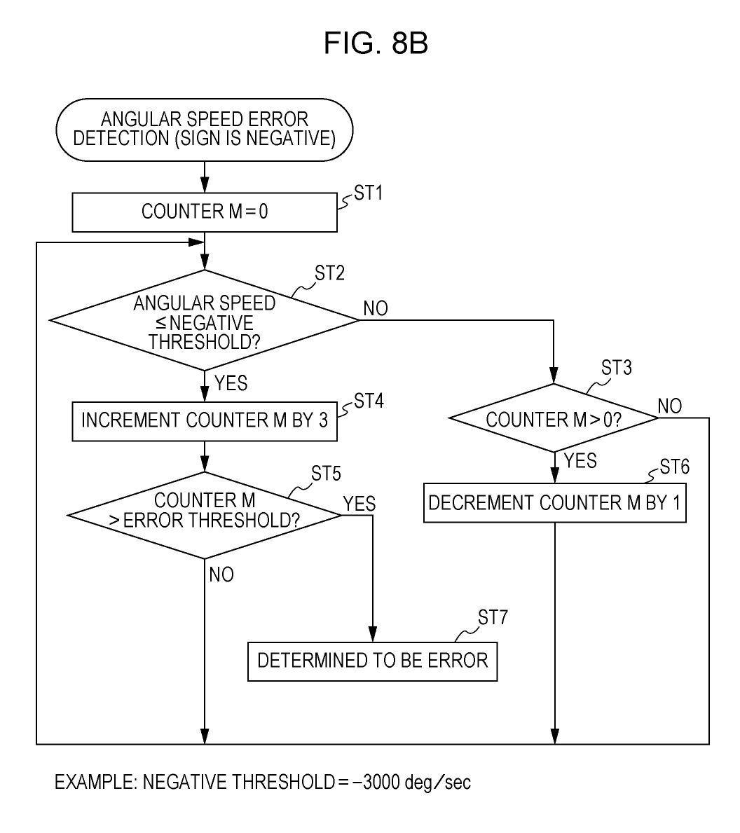

A method of detecting an angular speed error is described with reference to the flowcharts illustrated in FIG. 8A and FIG. 8B. FIG. 8A is a flowchart for explaining an increase or decrease in a first counter value P in the positive counter 26 and error determination, and FIG. 8B is a flowchart for explaining an increase or decrease in a second counter value M in the negative counter 27 and error determination.

In the positive counter 26 illustrated in FIG. 3, a value of 3 may be added when “ASMAV (deg/s)” (average angular speed) transmitted from the storage unit 25 is higher than or equal to a predetermined positive threshold, and a value of 1 is subtracted when “ASMAV (deg/s)” is lower than the predetermined positive threshold, whereby the first counter value P is obtained. Note that the subtraction may be performed when the first counter value P is larger than 0 (lower limit). Here, the positive threshold defined for the positive counter 26 may be, for example, 3000 (deg/s).

In the negative counter 27 illustrated in FIG. 3, a value of 3 may be added when “ASMAV (deg/s)” (average angular speed) transmitted from the storage unit 25 is lower than or equal to a predetermined negative threshold, and a value of 1 may be subtracted when “ASMAV (deg/s)” is higher than the predetermined negative threshold, whereby the second counter value M is obtained. Note that the subtraction is performed when the second counter value M is larger than 0 (lower limit). Here, the negative threshold defined for the negative counter 27 may be, for example, −3000 (deg/s).

As illustrated by steps ST1 in FIG. 8A and FIG. 8B, the first counter value P calculated by the positive counter 26 and the second counter value M calculated by the negative counter 27 are 0 (lower limit).

Hence, as illustrated in FIG. 4, since “ASMAV (deg/s)” (average angular speed) is “0” during a period from time “0” to time “5”, the average angular speed in step ST2 in FIG. 8A is always lower than the threshold 3000 (deg/s). Hence, the flow proceeds to step ST3, but since the first counter value P is “0”, the flow goes back to step ST2 without subtraction being performed. As a result, as illustrated in FIG. 4, the first counter value P calculated by the positive counter 26 during a period from time “0” to time “5” may continue to be “0”. Similarly, in the negative counter 27, the average angular speed in step ST2 in FIG. 8B always may be higher than the threshold −3000 (deg/s) during the period. Hence, the flow may proceed to step ST3, but since the second counter value M is “0”, the flow may go back to step ST2 without subtraction being performed. As a result, as illustrated in FIG. 4, the second counter value M calculated by the positive counter 26 during a period from time “0” to time “5” may continue to be “0”.

Referring to FIG. 4, during a period from time “6” to time “9”, “ASMAV (deg/s)” (average angular speed) may be “3025”. Hence, in the positive counter 26 the average angular speed always may be higher than the threshold (3000 deg/s) in step ST2 in Fig. BA. As a result, the flow may proceed to step ST4, where a value of 3 is added to the first counter value P. Then in step ST5, it may be determined whether or not the first counter value P has exceeded an error threshold. For example, the error threshold is set to “20” in the present embodiment.

As illustrated in FIG. 4, in the positive counter 26, until time “9”, a value of 3 may be added and the first counter value P may be increased to “12”. However, since this is smaller than the error threshold, it may not be determined that an error has occurred, and the flow may return from step ST5 to step ST2 in FIG. 8A.

As illustrated in FIG. 4, after and including time “10”, since “ASMAV (deg/s)” (average angular speed) continues to be lower than or equal to 3000 (deg/s), a value of 1 may be subtracted from the first counter value P in step ST3 in the positive counter 26 (refer to FIG. 4 and step ST6 in FIG. 8A). When subtraction is repeated, the first counter value P can eventually return to the initial value (P=0).

On the other hand, in the negative counter 27, since “ASMAV (deg/s)” (average angular speed) may continue to exceed the threshold “−3000 deg/s” until time “10”, the second counter value M may continue to be “0”. During a period from time “11” to time “14”, “ASMAV (deg/s)” (average angular speed) may be “−3025”. Hence, in the negative counter 27, the average angular speed may continue to be lower than the threshold “−3000 deg/s” in step ST2. As a result, the flow may proceed to step ST4, where a value of 3 may be added to the second counter value M. Then, in step ST5, it may be determined whether or not the second counter value M has exceeded an error threshold. For example, the error threshold may be set to “20” in the present embodiment.

As illustrated in FIG. 4, in the negative counter 27, a value of 3 may be added at times “11” to “14”, whereby the second counter value M may be increased to “12”. However since this is smaller than the error threshold, it may not be determined that an error has occurred, and the flow may return from step ST5 to step ST2 in FIG. 8B.

Further, as illustrated in FIG. 4, after and including time “15”, since “ASMAV (deg/s)” (average angular speed) is higher than −3000 (deg/s), a value of 1 may be subtracted from the second counter value M in step ST3 in the negative counter 27 (refer to FIG. 4 and step ST6 in FIG. 8B).

As illustrated in FIG. 4, since the maximum values of the first counter value P calculated by the positive counter 26 and the second counter value M calculated by the negative counter 27 both may be 12, which is smaller than the error threshold “20”, a pattern corresponding to the simulation results illustrated in FIG. 4 may be determined to be noise and is not detected as an error.

FIG. 5, similarly to FIG. 4, illustrates the simulation results of a pattern that is to be recognized as noise (pattern not to be detected as an error). Referring to FIG. 5, as illustrated in the left side graph, the angle abruptly may increase twice, at time “6” and time “8”.

“Angular speed AS”, “four-prior-data average ASMAV”, and “ASMAV (deg/s)” illustrated in FIG. 5 have been calculated similarly to those in FIG. 4. By comparing “ASMAV (deg/s)” (average angular speed) with respective thresholds set in the positive counter 26 and the negative counter 27 illustrated in FIG. 3, respective counter values may be increased or decreased (refer to FIG. 5, FIG. 8A, and FIG. 8B). Thereby, the maximum values of the first counter value P calculated by the positive counter 26 and the second counter value M calculated by the negative counter 27 both may become 15, as illustrated in FIG. 5. Here, when the error thresholds are set to “20” similarly to as in FIG. 4, a pattern corresponding to the simulation results illustrated in FIG. 5 may be determined to be noise and is not detected as an error, since the counter values may be smaller than the error thresholds.

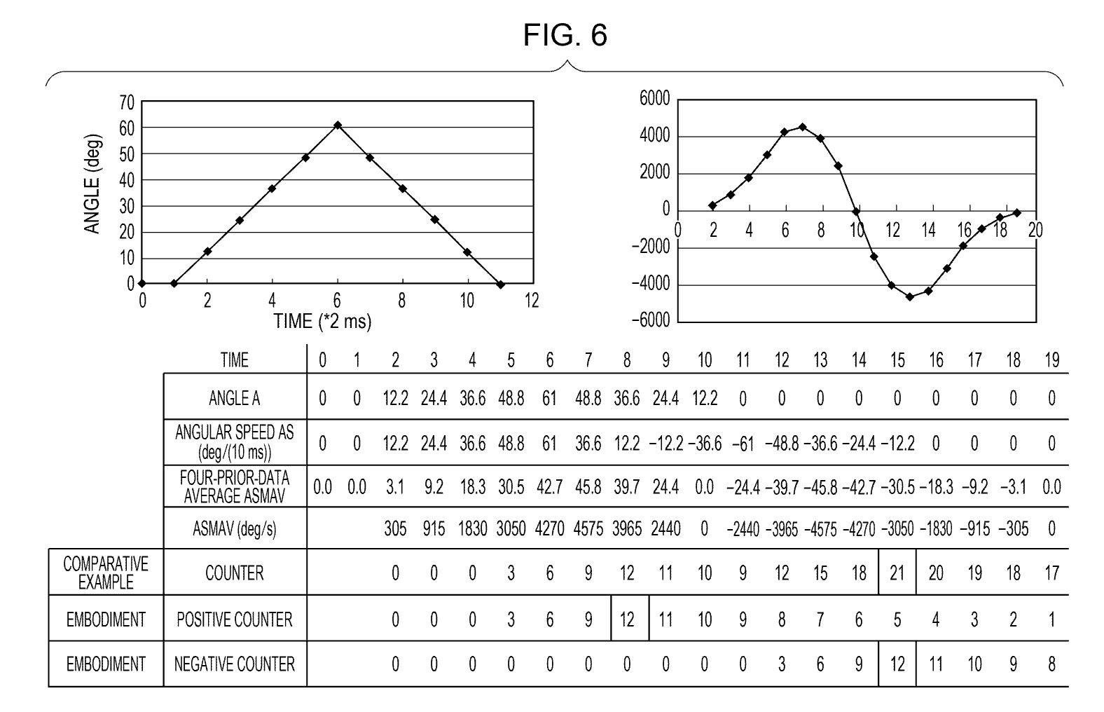

FIG. 6, similarly to FIGS. 4 and 5, illustrates the simulation results of a pattern that is to be recognized as noise (pattern not to be detected as an error). Referring to the left side graph of FIG. 6, although a change in angle with respect to “time” is gradual compared with those in FIGS. 4 and 5, such a change in angle illustrated in FIG. 6 also may be determined to be noise similarly to those in FIGS. 4 and 5.

“Angular speed AS”, “four-prior-data average ASMAV”, and “ASMAV (deg/s)” illustrated in FIG. 6 have been calculated similarly to those in FIG. 4. By comparing “ASMAV (deg/s)” (average angular speed) with respective thresholds set in the positive counter 26 and the negative counter 27 illustrated in FIG. 3, respective counter values may be increased or decreased (refer to FIG. 6, FIG. 8A, and FIG. 8B). Thereby, the maximum values of the first counter value P calculated by the positive counter 26 and the second counter value M calculated by the negative counter 27 both may become 12, as illustrated in FIG. 6. Here, when the error thresholds are set to “20” similarly to as in FIGS. 4 and 5, a pattern corresponding to the simulation results illustrated in FIG. 6 may be determined to be noise and may not be detected as an error, since the counter values are smaller than the error thresholds.

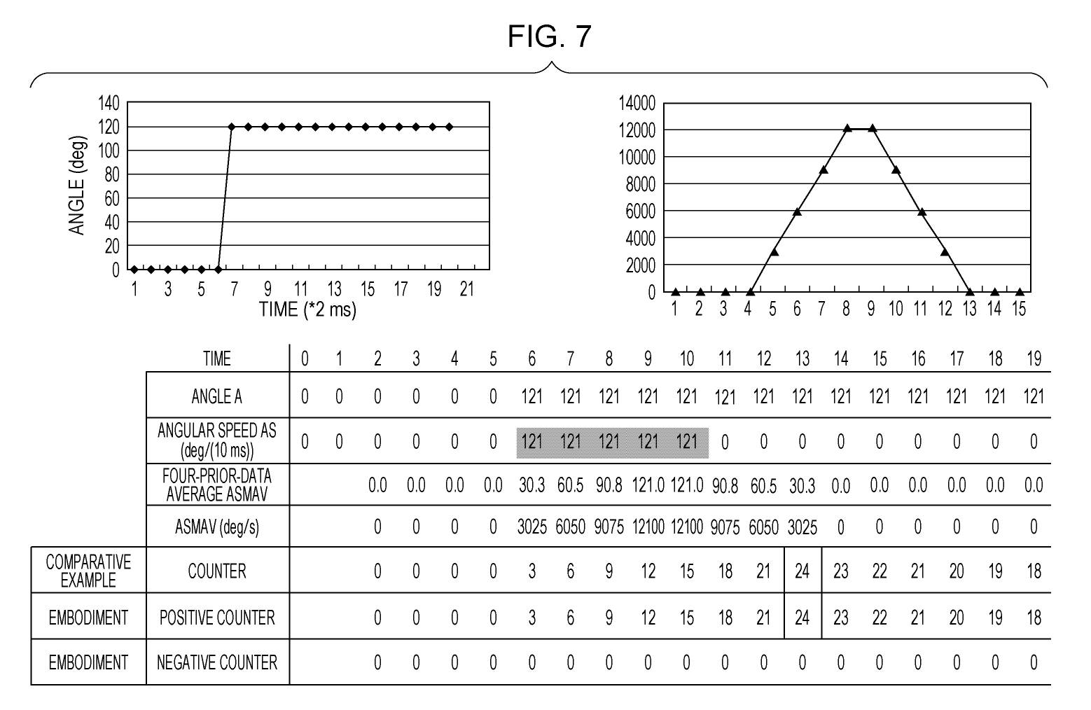

On the other hand, FIG. 7, different from FIGS. 4 to 6, illustrates the simulation results of a pattern which is not noise and is to be desirably detected as an error.

Referring to the left side graph of FIG. 7, when “time” changes from “5” to “6”, the angle abruptly may increase from “0” to “121”, and after time “6”, may continue to be “121”.

It is desired that such a state be not determined to be noise and be detected as an error due to a failure such as a short circuit in the electronic circuit 20 illustrated in FIG. 5.

As illustrated in FIG. 7, “angle A” may continue to be “0” from time “0” to time “5”, but may continue to be “121” after and including time “6”.

Referring to FIG. 7, “angular speed AS” (deg/(10 ms)) may be “121” from time “6” to time “10”, but after and including time “11”, since there is no change in “angle A” (change in angle is zero) since 10 ms before time “11”, “angular speed AS” (deg/(10 ms)) after and including time “11” is “0”.

Then, as illustrated in FIG. 7, “four-prior-data average ASMAV” and “ASMAV (deg/s)” (average angular speed) may be calculated, using the method described in FIG. 4. “ASMAV (deg/s)” (average angular speed) is illustrated as a graph on the right side of FIG. 7.

When comparing FIG. 7 with FIGS. 4 to 6, “ASMAV (deg/s)” (average angular speed) may be much higher in FIG. 7 than in FIGS. 4 to 6, and the state of high “ASMAV (deg/s)” (average angular speed) may continue for a long time. Further, as illustrated in FIG. 7, “ASMAV (deg/s)” (average angular speed) always may be higher than or equal to “0” and may not have a negative value.

When comparing “ASMAV (deg/s)” (average angular speed) obtained in FIG. 7 with thresholds (3000 for the positive counter 26, and −3000 for the negative counter 27), and calculating the counter values using the positive counter 26 and the negative counter 27, the first counter value P calculated by the positive counter 26 may increase to a maximum of “24”. On the other hand, the second counter value M calculated by the negative counter 27 may continue to be “0”.

As illustrated by the flowchart in FIG. 8A, when the first counter value P calculated by the positive counter 26 exceeds “20”, which is the error threshold, in step ST5, an error signal may be output (step ST7).

Note that in the simulation results illustrated in FIG. 7, the first counter value P calculated by the positive counter 26 has exceeded the error threshold. However, when “angle A” considerably swings to the negative side, the second counter value M calculated by the negative counter 27 may be larger than the error threshold “20” in step ST5 in FIG. 8B, and an error signal is output (step ST7 in FIG. 8B).

In this manner, a pattern corresponding to the simulation results illustrated in FIG. 7 may not be determined to be noise, and a failure can be detected as an error.

Hereinafter, a configuration in which only one counter is provided is described as a comparative example for the present embodiment described above.

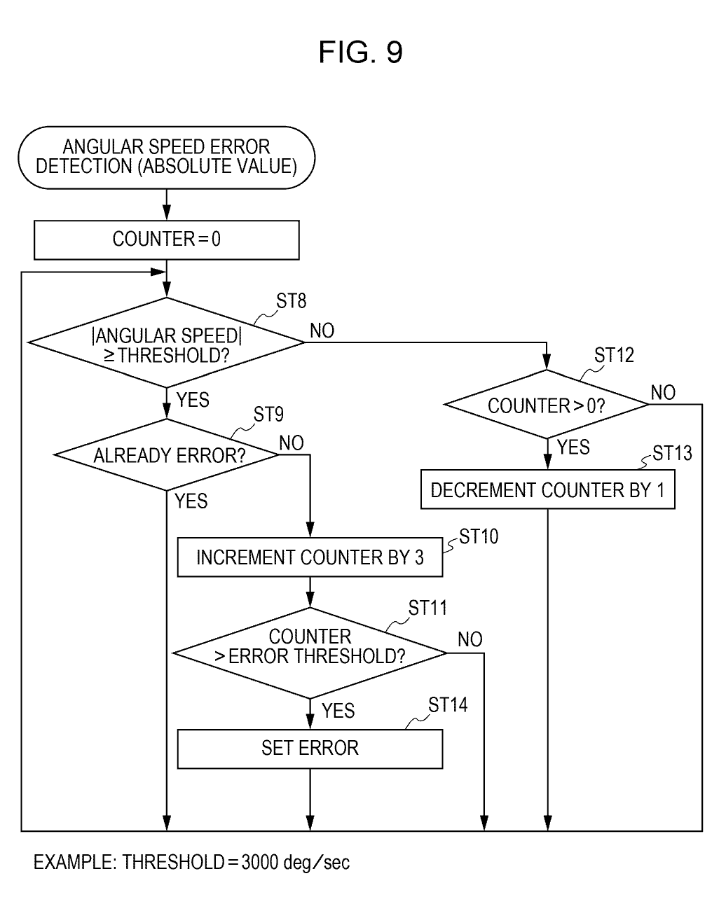

FIG. 9 is a flowchart for the comparative example. In the comparative example, to obtain a counter value, a value of 3 may be added when the absolute value of “ASMAV (deg/s)” (average angular speed) is higher than or equal to 3000 deg/s (threshold), and when the average angular speed is lower than 3000 deg/s, a value of 1 may be subtracted. In other words, when using a single counter, a value of 3 may be added for both positive and negative abnormal values, i.e., both when the average angular speed has become higher than or equal to 3000 deg/sec and when the average angular speed has become lower than or equal to −3000 deg/sec.

First, regarding the simulation results illustrated in FIG. 4, since the absolute value of “ASMAV (deg/s)” (average angular speed) exceeds 3000 deg/s (threshold) at times “6” to “9”, and at times “11” to “14” illustrated in FIG. 4, the flow may proceed from step ST8 to step ST9 illustrated in FIG. 9, and a value of 3 may be repeatedly added as a counter value in step ST10 unless an error state has already been entered. Then in step ST11, it may not be determined whether the counter value has exceeded an error threshold (the error threshold is set to “20”, for example, similarly to the above described embodiment).

Note that when the absolute value of “ASMAV (deg/s)” (average angular speed) is lower than or equal to 3000 deg/s (threshold), the flow may proceed from step ST8 to step ST12, and when the counter value is larger than “0”, a value of 1 may be subtracted from the counter value in step ST13.

In the simulation results illustrated in FIG. 4, the counter value may increase to a maximum of 23 when there is only a single counter as in the comparative example. As a result, the counter value may exceed “20” in step ST11 illustrated in FIG. 9, and an error signal is output (step ST14).

When there is only a single counter as in the comparative example, the counter value may exceed “20” also in the cases of FIGS. 5 and 6, whereby an error signal is output.

Hence, in the comparative example, patterns corresponding to the simulation results illustrated in FIGS. 4 to 6 are undesirably detected as errors, and cannot be ignored as noise.

In the case of the comparative example, when the error threshold for the counter value is set to a value larger than, for example, “20” used in the present embodiment, the patterns corresponding to the simulation results illustrated in FIGS. 4 to 6 can also be determined to be noise (not detected as errors). Since the maximum value of the counter may be “29” for the simulation results illustrated in FIG. 5 in the comparative example, if the error threshold is changed to, for example, “30”, in the comparative example, all the patterns corresponding to the simulation results illustrated in FIGS. 4 to 6 can be determined to be noise, without being detected as errors.

However, when the error threshold is increased to “30”, the pattern corresponding to the simulation results illustrated in FIG. 7, which is a pattern to be detected as an error, is also undesirably determined to be noise and cannot be detected as an error in the comparative example, since the maximum value of the counter value in the comparative example is “24”.

In the present embodiment, in which the counters 26 and 27 are provided, even when an abnormal average angular speed is detected, this may not be immediately determined to be an error. Although this is also true in the comparative example, the present embodiment is characterized in that the present embodiment may include the positive counter 26 having a positive threshold set therefor for the average angular speed and the negative counter 27 having a negative threshold set therefor for the average angular speed, rather than a single counter.

Hence, even when the angle abruptly considerably changes as illustrated in FIGS. 4 to 6, whereby the average angular speed (“ASMAV (deg/s)” illustrated in FIGS. 4 to 7) obtained by the arithmetic logic unit 19 (calculation means) within the microprocessor 24 considerably swings both to positive values and negative values, counting may be performed by the positive counter 26 when the average angular speed swings considerably to a positive value and counting may be performed by the negative counter 27 when the average angular speed swings considerably to a negative value. Hence, it may be easy to perform setting so as to make both the first counter value obtained by the positive counter 26 and the second counter value obtained by the negative counter 27 be smaller than the error threshold, thereby preventing noise from being detected as an error.

A state to be desirably detected as an error is a failure state in which, for example, a short circuit has occurred in the electronic circuit 20, whereby the detected angle with respect to time swings to a large value and that state continues (FIG. 7). In such a failure state, a period of time during which the average angular speed exceeds the threshold may becomes long for one of the positive counter 26 and the negative counter 27. Hence, the counter value associated with a failure can be made to be larger than the counter value associated with noise. For example, although the maximum counter values of the positive counter 26 and the negative counter 27 are “15” in FIGS. 4 and 5, the first counter value of the positive counter 26 can be made to be a maximum of “24” in FIG. 7.

Hence, setting can be appropriately made such that the counter value associated with noise (FIGS. 4 to 6) is smaller than the error threshold, and the counter value associated with a failure (FIG. 7) is larger than the error threshold.

On the other hand, in the comparative example, since the counter value associated with noise illustrated in FIG. 5 may exceed the counter value associated with a failure illustrated in FIG. 7, a configuration cannot be realized in which a change in angular speed associated with noise is not detected as an error and an abnormal change in angular speed associated with a failure can be detected as an error. In the comparative example, a possible state is either a state in which noise and a failure are both detected as errors or a state in which neither are detected as errors.

However, in the present embodiment, a configuration is realized in which a change in angular speed associated with noise may not be detected as an error while an abnormal change in angular speed associated with a failure can be detected as an error. Hence, an angular speed detection apparatus and a method for detecting an angular speed error having an advantage in terms of operational stability and error detection accuracy are realized.

In the present embodiment, values aa and cc to be added to the counters 26 and 27 may be made to be, for example, “3”, and values bb and dd to be subtracted from the counters 26 and 27 may be made to be, for example, “1”, whereby the added values may be made to be larger than the subtracted values. This may increase the difference between the maximum counter value associated with noise (FIGS. 4 to 6) and the maximum counter value associated with a failure (FIG. 7) and may make it easy to set the error threshold, whereby a configuration having an advantage in terms of operational stability and error detection accuracy is realized.

Control may be performed such that subtraction of the value bb is performed when the first counter value P at the subtraction is larger than a predetermined lower limit, and subtraction of the value dd is performed when the second counter value M at the subtraction is larger than a predetermined lower limit.

In other words, the lower limits of the counters may be set to, for example, “0”, and when the counter values are larger than “0” in steps ST3 illustrated in FIGS. 8A and 8B, a value of 1 is subtracted from the counters in steps ST6. When a configuration is employed in which a lower limit is not provided, for example, in the case where the counter value has decreased to a certain level, it may become necessary to suppress a decrease in error detection sensitivity through adjustment of the counter value such that the counter value does not become so small, by control in which the subtraction value is made smaller than “1”.

However, changing the subtracted value by checking the current counter value as described above may cause a load on the control system. Hence, by providing a lower limit in subtraction as in the present embodiment, the difference between the lower limit of each counter and the error threshold can always be made to be constant, whereby the error detection accuracy can be more effectively increased without making the control system complex.

By providing an error determination unit 28 separately from the positive counter 26 and the negative counter 27 in the microprocessor 24 illustrated in FIG. 3, processing of steps ST5 and ST7 can be performed using the error determination unit 28. Also, the error determination may be performed within the counters 26 and 27 through appropriate control.

When an error is detected, an error signal may be transmitted to the control unit 44. For example, the control unit 44, upon receipt of the error signal, may stop performing driving completely. By transmitting the error signal to the storage unit 25, transmission of “angle A” and “ASMAV (deg/s)” (average angular speed), which are transmitted at intervals of 10 ms, may be stopped. How the error signal is used may be appropriately changed in accordance with the types of apparatus in which the angular speed detection apparatus 9 of the present embodiment is provided.

For example, the angular speed detection apparatus of the present embodiment may be configured as a rudder angle sensor. In the present embodiment, even when an abnormal angular speed is detected, this is not immediately determined to be an error, and an error can be detected for an abnormal change in angular speed associated with a failure with high accuracy, whereby operational stability and reliability are increased.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An angular speed detection apparatus comprising:
calculation means configured to obtain, on the basis of angles detected at time intervals T1 that are shorter than a unit time over which angular speeds are calculated, the angular speeds at the time intervals T1 and calculate average angular speeds using a plurality of the prior angular speeds obtained at the time intervals T1;
a positive counter configured to obtain a first counter value by adding a predetermined value aa when any of the average angular speeds calculated at the time intervals T1 is higher than or equal to a predetermined positive threshold and subtracting a predetermined value bb when any of the average angular speeds calculated at the time intervals T1 is lower than the predetermined positive threshold; and
a negative counter configured to obtain a second counter value by adding a predetermined value cc when any of the average angular speeds calculated at the time intervals T1 is lower than or equal to a predetermined negative threshold and subtracting a predetermined value dd when any of the average angular speeds calculated at the time intervals T1 is higher than the predetermined negative threshold,
wherein it is determined that an error has occurred when the first counter value or the second counter value has exceeded an error threshold.

2. The angular speed detection apparatus according to claim 1, wherein the values aa and cc added to the counters are larger than the values bb and dd subtracted from the counters.

3. The angular speed detection apparatus according to claim 1, wherein subtraction of the value bb is performed when the first counter value is larger than a predetermined lower limit at the time of the subtraction and subtraction of the value dd is performed when the second counter value is larger than a predetermined lower limit at the time of the subtraction.

4. The angular speed detection apparatus according to claim 2, wherein subtraction of the value bb is performed when the first counter value is larger than a predetermined lower limit at the time of the subtraction and subtraction of the value dd is performed when the second counter value is larger than a predetermined lower limit at the time of the subtraction.

5. A method of detecting an angular speed error comprising:
obtaining, on the basis of angles detected at time intervals T1 that are shorter than a unit time for which angular speeds are calculated, the angular speeds at the time intervals Ti and calculating average angular speeds using a plurality of the prior angular speeds obtained at the time intervals T1;
obtaining a first counter value by adding a predetermined value aa when any of the average angular speeds calculated at the time intervals T1 is higher than or equal to a predetermined positive threshold and subtracting a predetermined value bb when any of the average angular speeds calculated at the time intervals T1 is lower than the predetermined positive threshold; and
obtaining a second counter value by adding a predetermined value cc when any of the average angular speeds calculated at the time intervals T1 is lower than or equal to a predetermined negative threshold and subtracting a predetermined value dd when any of the average angular speeds calculated at the time intervals T1 is higher than the predetermined negative threshold,
wherein it is determined that an error has occurred when the first counter value or the second counter value has exceeded an error threshold.

6. The method of detecting an angular speed error according to claim 5, wherein the values aa and cc added to the counters are larger than the values bb and dd subtracted from the counters.

7. The method of detecting an angular speed error according to claim 5 wherein subtraction of the value bb is performed when the first counter value is larger than a predetermined lower limit at the time of the subtraction and subtraction of the value dd is performed when the second counter value is larger than a predetermined lower limit at the time of the subtraction.

8. The method of detecting an angular speed error according to claim 6, wherein subtraction of the value bb is performed when the first counter value is larger than a predetermined lower limit at the time of the subtraction and subtraction of the value dd is performed when the second counter value is larger than a predetermined lower limit at the time of the subtraction.

9. An angular speed detection apparatus comprising:
a calculation unit configured to obtain, on the basis of angles detected at time intervals T1 that are shorter than a unit time over which angular speeds are calculated, the angular speeds at the time intervals T1 and calculate average angular speeds using a plurality of the prior angular speeds obtained at the time intervals T1;
a positive counter configured to obtain a first counter value by adding a predetermined value aa when any of the average angular speeds calculated at the time intervals T1 is higher than or equal to a predetermined positive threshold and subtracting a predetermined value bb when any of the average angular speeds calculated at the time intervals T1 is lower than the predetermined positive threshold; and
a negative counter configured to obtain a second counter value by adding a predetermined value cc when any of the average angular speeds calculated at the time intervals T1 is lower than or equal to a predetermined negative threshold and subtracting a predetermined value dd when any of the average angular speeds calculated at the time intervals T1 is higher than the predetermined negative threshold,
wherein it is determined that an error has occurred when the first counter value or the second counter value has exceeded an error threshold.
